(19) United States
(12) Patent Application Publication
(10) Pub. No.: US 2007/0046577 A1
(43) Pub. Date: Mar. 1, 2007

(54) Plasma display device

(76) Inventors: Sang-Hoon Yim, Yongin-si (KR); Tae-Weon Heo, Yongin-si (KR); Tae-Woo Kim, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/512,611

(22) Filed: Aug. 29, 2006

(30) Foreign Application Priority Data
Aug. 30, 2005 (KR) 10-2005-0080001

(51) Int. Cl. G09G 3/28

(52) U.S. Cl. 345/67

(57) ABSTRACT

A plasma display device is disclosed. The plasma display device includes a plurality of discharge cells and address electrodes passing through the discharge cells. Three discharge cells are associated with one pixel and each address electrode passes through at least two of the three discharge cells. Each discharge cell includes a first edge extending in a first direction and a second edge extending in a second direction crossing the first direction. The ratio of the length of the second edge to the length of the first edge is in the range of about ⅓ to about 4/3.

### CROSS-REFERENCE TO RELATED APPLICATION

This application claims priority to and the benefit of Korean Patent Application No. 10-2005-0080001 filed in the Korean Intellectual Property Office on Aug. 30, 2005, the entire content of which is incorporated herein by reference. This application also relates to U.S. patent application Ser. No. 11/482,459 filed on Jul. 7, 2006 (Attorney Docket Number: SDIYOU.021AUS), which is incorporated herein by reference.

### BACKGROUND

1. Field of the Invention

The present invention relates to a plasma display device.

2. Description of the Related Technology

Generally, a plasma display panel (PDP) device excites phosphors with vacuum ultraviolet radiation generated from plasma that is obtained through gas discharge. The PDP device displays desired images by the use of visible light such as red (R), green (G), and blue (B) color light generated by the excited phosphors.

The PDP device has been spotlighted as a flat panel display for TVs and for industrial purposes with several advantages. The PDP device can have a very large screen size of 60″ or more with a thickness of 10 cm or less. It provides excellent color representation without serious image distortion regardless of a viewing angle since it is a self emissive display, such as a cathode ray tube (CRT). The PDP device also provides high productivity and low production costs due to a simplified manufacturing process.

A three-electrode surface-discharge type PDP device may be taken as an example of a general PDP device. The three-electrode surface-discharge type PDP device includes a first substrate and a second substrate spaced apart from the first substrate. Sustain electrodes and scan electrodes are formed on the first substrate while address electrodes are formed on the second substrate. The address electrodes extend in a direction perpendicular to the sustain and scan electrodes. A discharge gas is filled between the two substrates.

Discharge cells are selected to be turned on by an address discharge generated between the scan and address electrodes. A sustain discharge, which actually displays a required image, occurs thereafter between the sustain and scan electrodes.

### SUMMARY OF CERTAIN INVENTIVE ASPECTS

One aspect of the present invention provides a plasma display device including i) opposing first and second substrates, ii) a plurality of discharge cells partitioning a space between the substrates, and iii) an address electrode extending in a first direction and being located on the first substrate. Among the plurality of discharge cells, centers of three discharge cells corresponding to one pixel are arranged in a triangular pattern. Each address electrode passes by at least two of the three discharge cells. Each discharge cell includes i) a first edge extending in a first direction, and ii) a second edge extending in a second direction crossing the first direction. The length of the second edge with respect to the length of the first edge is in the range of about ⅓ to about 4/3.

The length of the second edge with respect to the length of the first edge may be in the range of about ¾ to about 4/3, or may be about ¾. A second mean length of the pixel with respect to the first mean length of the pixel may be in the range of about 2/4.5 to about 8/4.5. Here, the second mean length of the pixel is defined as the length of the second edge doubled and the first mean length of the pixel is defined as the cross-sectional area of the pixel, in the first and second directions, divided by the second mean length of the pixel. The first mean length of the pixel with respect to the second mean length of the pixel may be in the range of about 1.0 to about 8/4.5, or may be about 1.0.

The cross-section of the discharge cell may be substantially rectangular shaped. An imaginary line extended from the second edge shared with two of the three discharge cells may pass by the center of the remaining discharge cell. Two of the three discharge cells may be adjacent to each other in the first direction.

The plasma display device may further include phosphor layers formed in the discharge cells. Phosphor layers formed in the three discharge cells are different in colors, respectively.

The plasma display device may further include a plurality of display electrodes extending in the second direction and being located on the second substrate. The plurality of display electrodes may include i) a plurality of sustain electrodes, and ii) a plurality of scan electrodes. The sustain and scan electrodes may be alternately arranged in the first direction. Two address electrodes and two scan electrodes may pass by the three discharge cells. One address electrode may pass by two of the three discharge cells adjacent to each other in the first direction and the other address electrode may pass by the remaining discharge cell. One scan electrode may pass by two of the three discharge cells adjacent to each other in the second direction and the other scan electrode may pass by the remaining discharge cell. The plurality of display electrodes may include i) a plurality of bus electrodes extending in the second direction, and ii) a plurality of transparent electrodes extending from the plurality of bus electrodes and having a width that is greater than a width of the bus electrodes.

Another aspect of the present invention provides a plasma display device including a plurality of discharge cells three of which form a single pixel. A selected single address electrode is configured to address two discharge cells of a selected pixel. The pixel include a first edge extending in a direction to be substantially parallel to the address electrode, and a second edge extending in a direction to cross the address electrode and sharing a corner of the pixel with the first edge. The ratio of the length of the second edge to the length of the first edge is in the range of about ⅓ to about 4/3. Each of the discharge cells may be substantially rectangular in shape.

Another aspect of the present invention provides a plasma display device including a plurality of discharge cells three of which form a single pixel. A selected single address electrode is configured to address two discharge cells of a selected pixel. In one embodiment, the horizontal and vertical distances of a cross-section of a discharge cell are determined such that a discharge efficiency and a voltage margin are optimized. In another embodiment, the horizontal and vertical distances are determined based on the combination of a discharge efficiency and a voltage margin. The discharge efficiency is defined as the ratio of brightness to power consumption of the plasma display device and the voltage margin is defined as the difference between a minimum sustain discharge voltage and a discharge firing voltage.

The ratio of the horizontal distance to the vertical distance may be in the range of about ⅓ to about 4/3, and the horizontal distance may be measured in a direction crossing the address electrode. The discharge efficiency and the voltage margin may be inversely proportional to each other.

### BRIEF DESCRIPTION OF THE DRAWINGS

FIG. 1 is an exploded perspective view of a plasma display device in accordance with an embodiment.

FIG. 2 is a cross-sectional view taken along the line II-II of FIG. 1.

FIG. 3 is a plan view of an arrangement of pixels and electrodes in accordance with the embodiment.

FIG. 4 is an enlarged plan view of discharge cells of FIG. 1.

FIG. 5 is a modified exemplary view of discharge cells of FIG. 4.

FIG. 6 is an enlarged plan view of discharge cells in accordance with another embodiment.

FIG. 7 is a modified exemplary view of discharge cells of FIG. 6.

FIG. 8 is an enlarged plan view of discharge cells in accordance with a further embodiment.

FIG. 9 is a modified exemplary view of discharge cells of FIG. 8.

FIG. 10 is an enlarged plan view of discharge cells in accordance with a still further embodiment.

FIG. 11 is a modified exemplary view of discharge cells of FIG. 10.

### DETAILED DESCRIPTION OF CERTAIN INVENTIVE EMBODIMENTS

With reference to the accompanying drawings, embodiments of the present invention will now be described in order for those skilled in the art to be able to implement it. As those skilled in the art would realize, the described embodiments may be modified in various different ways, all without departing from the spirit or scope of the present invention. Wherever possible, the same reference numbers will be used throughout the drawing(s) to refer to the same or similar parts.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to limit the invention. As used herein, the singular forms “a”, “an”, and “the” may include the plural forms as well, unless the context clearly indicates otherwise. It will be further understood that the terms “comprises/comprising” and “includes/including” when used in this specification specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper”, and the like, may be used herein for ease of description to describe the relationship between one element or feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross-sectional illustrations that are schematic illustrations of embodiments of the present invention. As such, variations from the shapes of the illustrations as a result, for example, of manufacturing techniques and/or tolerances, are to be expected. Thus, embodiments should not be construed to limit to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes may not illustrate the precise shape of a region and are not intended to limit the scope of the present invention.

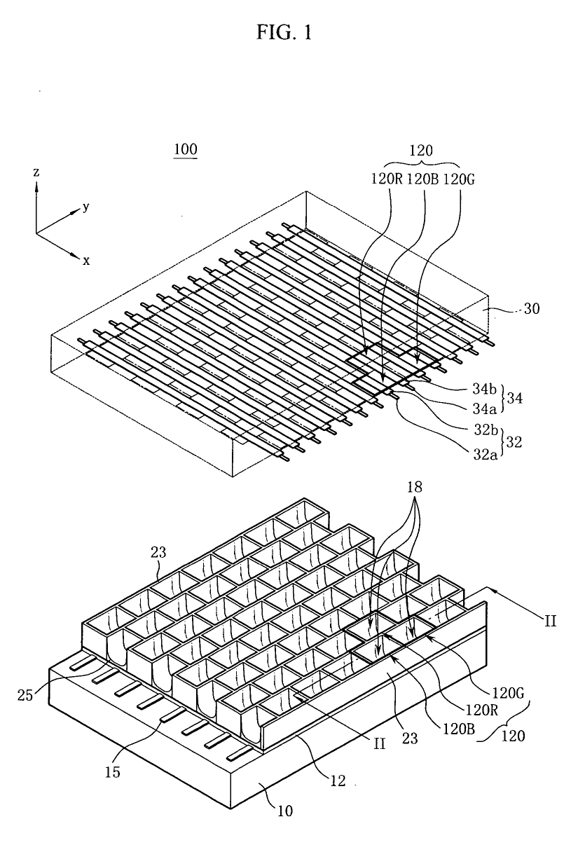

FIG. 1 illustrates an exploded perspective view of a plasma display device 100 in accordance with an embodiment.

The plasma display device 100 includes rear and front substrates 10 and 30 that are spaced apart from each other by a predetermined distance in a parallel manner. A space between the substrates 10 and 30 is filled with a discharging gas such as xenon (Xe) and/or neon (Ne).

A plurality of barrier ribs 23 with a predetermined height are located in the space. The space is partitioned into a plurality of discharge cells 18 by the plurality of barrier ribs 23. Red, green, and blue phosphor layers 25 are respectively formed in the discharge cells 18.

Each discharge cell 18 corresponds to three subpixels 120R, 120G, and 120B. Three discharge cells 18 are associated with one pixel 120. A pixel 120 is defined by the plurality of barrier ribs 23 in a predetermined pattern. The pixel 120 includes three subpixels 120R, 120G, and 120B which are arranged in a triangular pattern. Each of the three subpixels 120R, 120G, and 120B emits red, green, and blue color light, respectively.

In one embodiment, the discharge cells 18 are substantially shaped to be rectangular parallelepipeds. Each discharge cell 18 is shaped to have an upper portion that is open. The cross-section of the discharge cells 18, in the x-axis and y-axis directions, is substantially rectangular shaped.

A plurality of address electrodes 15 are located on the rear substrate 10. The address electrodes 15 extend in the y-axis direction and are arranged along the x-axis direction with a predetermined interval between each other. The plurality of address electrodes 15 are located between the rear substrate 10 and the plurality of discharge cells 18. A dielectric layer 12 is coated on the rear substrate 10 covering the address electrodes 15.

A plurality of display electrodes including sustain electrodes 32 and scan electrodes 34 extend in the x-axis direction. The plurality of sustain and scan electrodes 32 and 34 are arranged in a direction to cross the plurality of address electrodes 15. The plurality of sustain and scan electrodes 32 and 34 are not electrically connected to the plurality of address electrodes 15. The plurality of sustain and scan electrodes 32 and 34 are alternately arranged in the y-axis direction. Adjacent sustain and scan electrodes 32 and 34 in each discharge cell form a discharge gap in a plane pattern. The discharge gap is determined by transparent electrodes 32b and 34b.

Each sustain electrode 32 includes a bus electrode 32a and a transparent electrode 32b, while each scan electrode 34 includes a bus electrode 34a and a transparent electrode 34b. The transparent electrodes 32b and 34b extend from the bus electrodes 32a and 34a, respectively. The widths of the transparent electrodes 32b and 34b are respectively wider than those of the bus electrodes 32a and 34a.

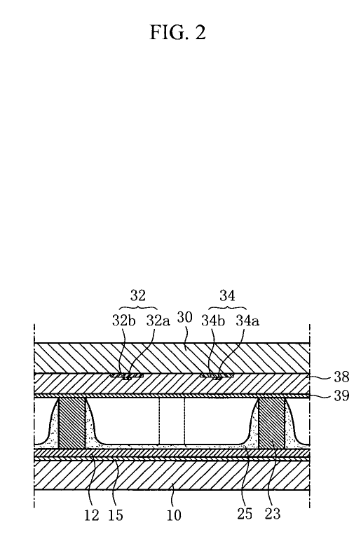

FIG. 2 illustrates a cross-section taken along the line II-II of FIG. 1.

The widths of the bus electrodes 32a and 34a may be as thin as possible so long as the bus electrodes 32a and 34a can maintain their minimum conductivity for applying a driving voltage to the transparent electrodes 32b and 34b, respectively. The bus electrodes 32a and 34a may contain metallic materials with good conductivity. Since the bus electrodes 32a and 34a may not be transparent, they can absorb ambient light and therefore, a contrast ratio can be increased. The transparent electrodes 32b and 34b may contain transparent materials such as indium tin oxide (ITO).

The sustain and scan electrodes 32 and 34 are covered with a dielectric layer 38. The dielectric layer 38 protects the sustain and scan electrodes 32 and 34 from a gas discharge and forms or accumulates wall discharges. A protection layer 39, for example, made of MgO, covers the dielectric layer 38. The protection layer 39 protects the dielectric layer 38 from the gas discharge and increases the second electron discharge coefficient. Accordingly, it is possible to reduce a discharge firing voltage.

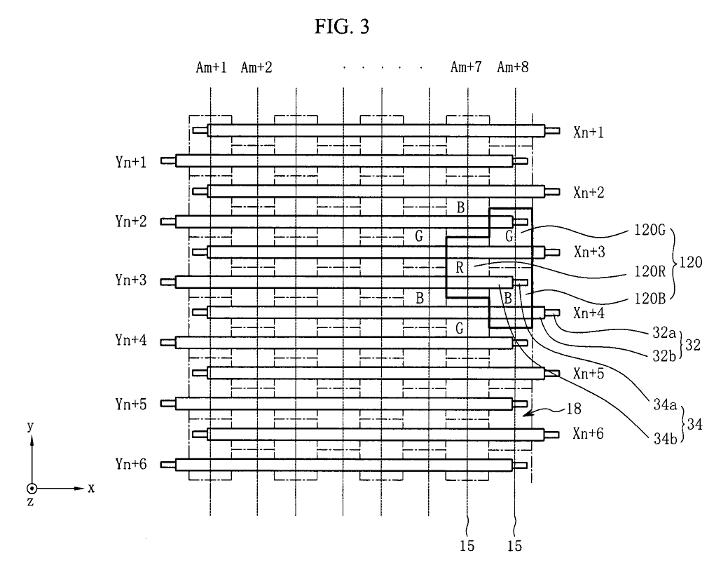

FIG. 3 illustrates a plan view of an arrangement of pixels and electrodes of FIG. 1.

The three subpixels 120R, 120G, and 120B surrounded by a thick line as illustrated in FIG. 3 are the same as the three subpixels 120R, 120G, and 120B illustrated in FIG. 1. Centers of the three subpixels 120R, 120G, and 120B are arranged in a triangular pattern. Two of the three subpixels 120R, 120G, and 120B are arranged to be adjacent to each other in the y-axis direction, such as subpixels 120G and 120B. Phosphor layers formed in the two subpixels 120G and 120B are different in colors.

One address electrode 15(Am+8) passes by the two subpixels 120G and 120B included in a single pixel 120 and another address electrode 15(Am+7) passes by the remaining subpixel 120R. In addition, two scan electrodes 34 pass by the single pixel 120. The three subpixels 120R, 120G, and 120B are selected to be discharged by the two address electrodes 15 and the two scan electrodes 34.

The relationship between the electrodes and the discharge cells is explained in detail below. One pixel 120 is chosen for explanation and different reference numerals are used to represent electrodes that pass by the one pixel 120. Reference numerals A, X, and Y represent the address electrodes, the sustain electrodes, and the scan electrodes, respectively.

One scan electrode Yn+3 passes by the two subpixels 120R and 120B, which are adjacent to each other in the x-axis direction, and another scan electrode Yn+2 passes by the remaining subpixel 120G. One sustain electrode Xn+3 passes by the two subpixels 120R and 120G and another sustain electrode Xn+4 passes by the remaining subpixel 120B.

In one embodiment, the two sustain electrodes Xn+3 and Xn+4 pass by the same pixel 120 that the two scan electrodes Yn+2 and Yn+3 pass by. The scan electrode Yn+3 applies a voltage to the two subpixels 120R and 120B while the scan electrode Yn+2 applies a voltage to the subpixel 120G. The sustain electrode Xn+4 applies a voltage to the subpixel 120B while the sustain electrode Xn+3 applies a voltage to the two subpixels 120R and 120G.

Discharge gaps are formed in the pixel 120 by the two sustain electrodes Xn+3 and Xn+4 and the two scan electrodes Yn+2 and Yn+3. Therefore, the pixel 120 is driven by the two sustain electrodes Xn+3 and Xn+4 and the two scan electrodes Yn+2 and Yn+3. In addition, two discharge cells 18 adjacent to each other in the y-axis direction are each driven by two sustain and scan electrodes, which are alternately arranged in the y-axis direction.

In one embodiment, one pixel 120 is driven by two address electrodes 15. That is, the number of address electrodes is reduced to two. This reduces number of address electrode terminals so that it is easy to design the terminals.

Conventionally, three address electrodes were used to drive a single pixel in a typical plasma display device. As the resolution of the plasma display device has increased, the discharge cells have been gradually reduced in size. As a result, capacitance between neighboring address electrodes increases and energy consumption also increases as the gap between the three address electrodes becomes shorter. However, a single pixel can be driven by using two address electrodes in the plasma display device in accordance with an embodiment, and therefore, it is possible to maintain enough space to arrange the address electrodes. As a result, power consumption for driving the address electrodes can be greatly reduced.

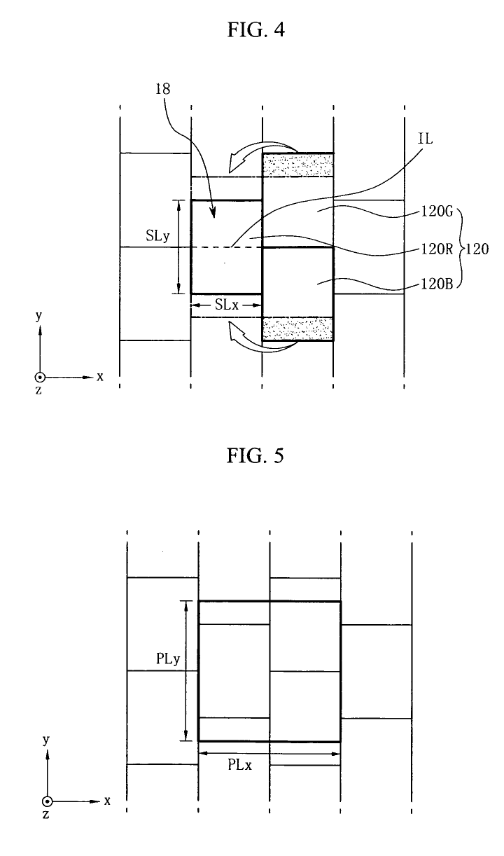

FIG. 4 illustrates an example of arranging the discharge cells 18 included in one pixel 120 for optimally maintaining discharge efficiency and voltage margin. The discharge efficiency and voltage margin can be optimized by controlling a size of the discharge cells 18.

Generally, the smaller the size of the discharge cells 18 is, the better the image quality of the plasma display device is. Thus, theoretically, the image quality can be continuously improved by reducing the size of a pixel. However, due to a manufacture limitation, the size of the discharge cell, including the cross section area thereof, is generally fixed.

The discharge efficiency may be defined as the ratio of brightness to power consumption, for example. Generally, as the gap between the scan and sustain electrodes (or the y-axis directional distance of a discharge cell 18 in FIG. 3) becomes greater, the discharge efficiency increases.

The voltage margin (or a memory margin) may be defined as the difference between a minimum sustain discharge voltage and a discharge firing voltage. The discharge cell 18 needs a sufficient voltage margin in order to maintain a stable voltage for discharge even if an unstable voltage is applied thereto. Generally, as the sustain-scan gap decreases, the voltage margin increases. However, as in the discharge efficiency, the manufacture requirement limits the minimum distance of the gap. A dimension of the discharge cell 18 depending on the aforementioned discharge efficiency and voltage margin is explained below with reference to FIG. 4.

The number of discharge cells 18, assorted with the resolution of the PDP, for example 850 by 480 or 1920 by 1080, is fixed in accordance with the size of the plasma display device, for example 42 inches, 80 inches, and 100 inches. In this case, the discharge efficiency and voltage margin of the plasma display device depends on the size of a discharge cell.

For example, as illustrated in FIG. 4, one discharge cell 18 has two pairs of edges. A first edge SLy extends in the y-axis direction, while a second edge SLx extends in the x-axis direction. The discharge efficiency is proportional to the length of the first edge SLy while the voltage margin is proportional to the length of the second edge SLx. For example, if the length of the first edge SLy increases, the discharge efficiency increases while the voltage margin decreases. On the contrary, if the length of the second edge SLx increases, the voltage margin increases while the discharge efficiency decreases. Therefore, the lengths of the first and second edges may be optimized in order to improve discharge efficiency and voltage margin together.

In one embodiment, the length of the second edge SLx with respect to the length of the first edge SLy may be in the range of about ⅓ to about 4/3. As a result, discharge efficiency and voltage margin are suitably maintained. In another embodiment, the ratiois determined such that a discharge efficiency and a voltage margin are optimized. In another embodiment, the ratio is determined based on the combination of a discharge efficiency and a voltage margin.

Within this range, as the ratio SLx/SLy becomes close to about ⅓, the length of the second edge SLx becomes shorter than the length of the first edge SLy, and consequently the discharge efficiency increases while the voltage margin decreases. The above ratio is appropriate when the plasma display device is designed under the condition that the discharge efficiency is high at the expense of the voltage margin.

On the other hand, within the above range, as the ratio SLx/SLy becomes close to about 4/3, the length of the second edge SLx becomes longer than the length of the first edge SLy, and consequently the voltage margin increases while the discharge efficiency decreases. The above ratio is appropriate if the plasma display panel is designed to obtain a greater voltage margin to the detriment of the discharge efficiency.

In one embodiment, as illustrated in FIG. 4, an imaginary line IL is extended from the second edge that is shared with the two discharge cells 120G and 120B. The imaginary line IL passes through the center of the discharge cell 120R.

For the purposes of the following description, in this arrangement, the shaded areas of the subpixels 120G and 120B can be moved to upper and lower sides of the subpixel 120R, respectively, as indicated by arrows in FIG. 4. Since each of the shaded areas is the same as an upper and a lower area of the subpixel 120R, respectively, where the shaded areas will be moved to, a rectangle is made as illustrated in FIG. 5. In this case, PLy refers to a vertical length of the rectangle and PLx refers to a horizontal length of the rectangle. Here, PLy is defined as a first mean length of the pixel 120 and PLx is defined as a second mean length thereof. The area of the rectangle illustrated in FIG. 5 is the same as the cross-sectional area of the pixel 120 in the x-axis and y-axis directions. Therefore, PLx times PLy gives the cross-sectional area of the pixel 120.

The second mean length PLx with respect to the first mean length PLy is in the range of about 2/4.5 to about 8/4.5. The discharge efficiency and the voltage margin of the plasma display device are optimized within this range. Further, the second mean length PLx with respect to the first mean length PLy may be in the range of about 1.0 to about 8/4.5.

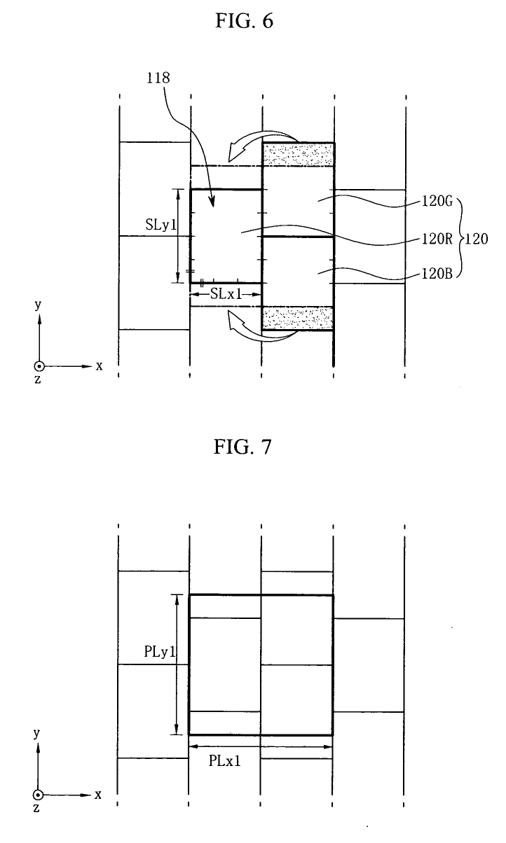

FIGS. 6 to 11 illustrate various exemplary embodiments of the discharge cells for optimally maintaining discharge efficiency and voltage margin by controlling the lengths of edges of the discharge cells. The discharge cells illustrated in FIGS. 6 to 11 have similar configurations to that of the discharge cell illustrated in FIGS. 4 and 5 in that an imaginary line extended from the second edge shared by the two discharge cells arranged in the y-axis direction passes through the center of the other discharge cell.

As illustrated in FIG. 6, one fourth of the length of the first edge SLy1 is substantially the same as one third of the length of the second edge SLx1. That is, the length of the second edge SLx1 with respect to the length of the first edge SLy1 is about ¾. This configuration can be adapted to a plasma display device whose resolution is about 1290 by about 1080. The size of the plasma display device can be up to 80 inches.

In the discharge cell 118 illustrated in FIG. 6, for example, the length of the second edge SLx1 may be about 0.288 mm and the length of the first edge SLy1 may be about 0.384 mm. In one embodiment, the length of the second edge SLx1 may be at least 0.200 mm in order to maintain a minimum voltage margin.

As before, in this arrangement, shaded areas of the subpixels 120G and 120B can be moved to upper and lower sides of the subpixel 120R, respectively, as indicated by arrows in FIG. 6. The vertical length of the shaded area is substantially the same as one fourth of the length of the first edge SLy1.

Therefore, as illustrated in FIG. 7, a square is made. That is, the first mean length PLy1 of the pixel 120 is substantially the same as the second mean length PLx1 of the pixel 120. In other words, the second mean length PLx1 with respect to the first mean length PLy1 is about 1.0. As a result, combination of the discharge efficiency and voltage margin of the plasma display device is optimized well.

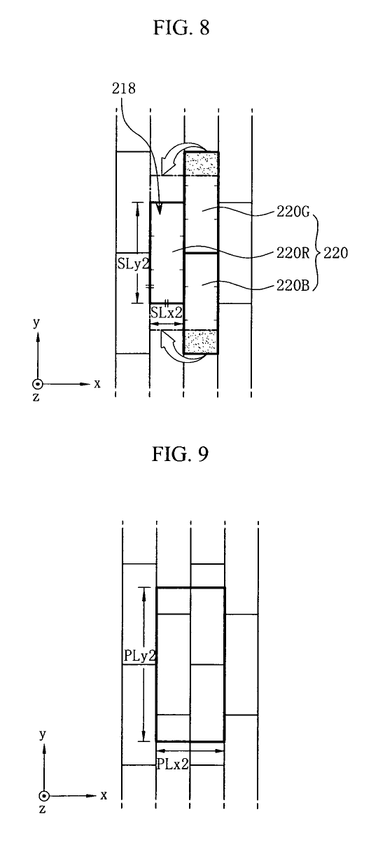

FIG. 8 illustrates a discharge cell 218 in which the length of the first edge SLy2 is much longer than the length of the second edge SLx2. As illustrated in FIG. 8, one third of the length of the first edge SLy2 is substantially the same as the length of the second edge SLx2. That is, the length of the second edge SLx2 with respect to the length of the first edge SLy2 is about ⅓.

Again, in this arrangement, shaded areas of the subpixels 220G and 220B can be moved to upper and lower sides of the subpixel 220R, respectively, as indicated by arrows in FIG. 8. The vertical length of the shaded area is substantially the same as one fourth of the length of the first edge SLy2.

Therefore, as illustrated in FIG. 9, a rectangle is made. In this case, the second mean length PLx2 with respect to the first mean length PLy2 is about 2/4.5. As a result, in comparison with the embodiment illustrated in FIG. 6, the discharge efficiency increases while the voltage margin decreases.

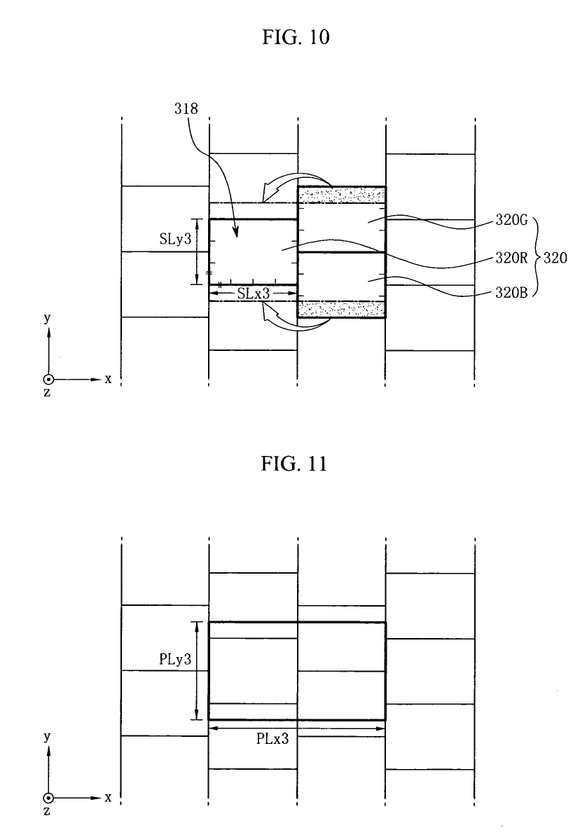

FIG. 10 illustrates a discharge cell 318 in which the length of the second edge SLx3 is longer than the length of the first edge SLy3. As illustrated in FIG. 10, one third of the length of the first edge SLy3 is substantially the same as one fourth of the length of the second edge SLx3. That is, the length of the second edge SLx3 with respect to the length of the first edge SLy3 is about 4/3.

Once more, in this arrangement, shaded areas of the subpixels 320G and 320B can be moved to upper and lower sides of the subpixel 320R, respectively, as indicated by arrows in FIG. 10. The vertical length of the shaded area is substantially the same as one fourth of the length of the first edge SLy3.

Therefore, as illustrated in FIG. 11, a rectangle is made. In this case, the second mean length PLx3 with respect to the first mean length PLy3 is about 8/4.5. As a result, in comparison with the embodiment illustrated in FIG. 6, the discharge efficiency decreases while the voltage margin increases.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display device, comprising:
first and second substrates opposing each other;
a plurality of discharge cells partitioning a space between the substrates, wherein centers of three discharge cells associated with one pixel are arranged in a generally triangular pattern; and
address electrodes extending in a first direction and being located on the first substrate, wherein two of the three discharge cells are configured to be driven by a single address electrode, and
wherein each of the discharge cells comprises:
a first edge extending in the first direction; and
a second edge extending in a second direction crossing the first direction and sharing a corner of the discharge cell with the first edge,
wherein the ratio of the length of the second edge to the length of the first edge is in the range of about ⅓ to about 4/3.

2. The device of claim 1, wherein the ratio is in the range of about ¾ to about 4/3.

3. The device of claim 2, wherein the ratio is about ¾.

4. The device of claim 1, wherein the mean ratio of a second mean length of a pixel to a first mean length of the pixel is in the range of about 2/4.5 to about 8/4.5,
where, the second mean length of the pixel is defined as double the length of the second edge, and the first mean length of the pixel is defined as the cross-sectional area of the pixel, in the first and second directions, divided by the second mean length of the pixel.

5. The device of claim 4, wherein the mean ratio is in the range of about 1.0 to about 8/4.5.

6. The device of claim 5, wherein the mean ratio is about 1.0.

7. The device of claim 4, wherein the cross-section of the discharge cell is substantially rectangular shaped.

8. The device of claim 1, wherein an imaginary line extended from the second edge shared with the two of the three discharge cells passes through the center of the remaining discharge cell.

9. The device of claim 1, wherein the two of the three discharge cells are adjacent to each other in the first direction.

10. The device of claim 1, further comprising:
phosphor. layers formed in the discharge cells, wherein phosphor layers formed in the three discharge cells are different in colors, respectively.

11. The device of claim 1, further comprising
a plurality of display electrodes extending in the second direction and being located on the second substrate, wherein the plurality of display electrodes comprise:
a plurality of sustain electrodes; and
a plurality of scan electrodes, wherein the sustain and scan electrodes are alternately arranged in the first direction.

12. The device of claim 11, wherein two address electrodes and two scan electrodes are assigned to the three discharge cells, and
wherein one address electrode passes through two of the three discharge cells adjacent to each other in the first direction and the other address electrode passes through the remaining discharge cell, and
wherein one scan electrode passes through two of the three discharge cells adjacent to each other in the second direction and the other scan electrode passes through the remaining discharge cell.

13. The device of claim 11, wherein the plurality of display electrodes comprise:
a plurality of bus electrodes extending in the second direction; and
a plurality of transparent electrodes extending from the plurality of bus electrodes and having a width that is greater than a width of the bus electrodes.

14. A plasma display device, comprising:
a plurality of discharge cells three of which form a single pixel,
wherein a selected single address electrode is configured to address two discharge cells of a selected pixel, and
wherein the pixel comprises:
a first edge extending in a direction that is substantially parallel to the address electrode; and
a second edge extending in a direction that crosses the address electrode and shares a corner of the pixel with the first edge, and
wherein the ratio of the length of the second edge to the length of the first edge is in the range of about ⅓ to about 4/3.

15. The device of claim 14, wherein each of the discharge cells is substantially rectangular in shape.

16. A plasma display device, comprising:
a plurality of discharge cells three of which form a single pixel,
wherein a selected single address electrode is configured to address two discharge cells of a selected pixel, and
wherein the horizontal and vertical distances of a cross-section of a discharge cell are determined based on the combination of a discharge efficiency and a voltage margin, and wherein the discharge efficiency is defined as the ratio of brightness to power consumption of the plasma display device and the voltage margin is defined as the difference between a minimum sustain discharge voltage and a discharge firing voltage.

17. The device of claim 16, wherein the ratio of the horizontal distance to the vertical distance is in the range of about ⅓ to about 4/3, and wherein the horizontal distance is measured in a direction crossing the address electrode.

18. The device of claim 17, wherein the ratio is in the range of about ¾ to about 4/3.

19. The device of claim 16, wherein the discharge efficiency and the voltage margin are inversely proportional to each other.
